(19) United States
(12) Patent Application Publication
(10) Pub. No.: US 2015/0028106 A1
(43) Pub. Date: Jan. 29, 2015

(54) Method Of Manufacturing A Smart Card

(71) Applicant: Cardmatix Co., Ltd., Dongguan (CN)

(72) Inventor: Chi Keung LEE, Hong Kong (HK)

(21) Appl. No.: 14/340,659

(22) Filed: Jul. 25, 2014

(30) Foreign Application Priority Data
Jul. 26, 2013 (HK) HK13108763.3

(51) Int. Cl. G06K 19/077

(52) U.S. Cl. CPC G06K 19/07754; G06K 19/07779
USPC 235/488; 438/106

(57) ABSTRACT

A method of manufacturing a smart card (20) embedded with an integrated circuit module (28) and an antenna coil (8) includes step (a), embedding an antenna coil (8) on a core sheet (6), (b), laminating the core sheet (6) with a number of outer sheets (10, 12, 14, 16) to form a laminated panel (18), (c), forming a cavity (22) in the laminated panel (18) to expose two ends (24) of the antenna coil (8), and (d), connecting two electric contact regions (30) of an integrated circuit module (28). The exposed ends (24) of the antenna coil (8) are connected by a mezzanine electrode diffusion welding method, controlled by a transformer output manipulation energy output control method.

### TECHNICAL FIELD

This invention relates to a method of manufacturing a card embedded with at least one integrated circuit module and an antenna coil, generally known as an “IC card” or “Smart card”.

### BACKGROUND

Smart cards have been widely used nowadays as data carriers. As the integrated circuit (IC) module in the smart card can store both data and programme, smart cards can be used remote of a computer terminal. Smart cards are used as telephone cards, credit cards, identification cards, and electronic wallets (e.g. in traffic systems).

Smart cards may be generally classified as contact cards and contact-less cards. For contact cards, at least a major surface of the IC module with a read/write interface is exposed to the outside environment. When in use, the read/write interface of the smart card is in direct physical contact with a read/write head of a computer terminal or processor, whereby data may be written into or read from the IC module in the card.

As to contact-less cards, such are provided with coils of an electrically conducting wire (e.g. copper wire), which is secured at or adjacent to its two ends with the IC module, which is fully embedded within the smart card. The coil of copper wire acts as an antenna for transmitting and/or receiving radio frequency (RF) signals. The IC module may then be coupled to an external system (such as a computer system) by RF transmission. In this case, the IC module needs not be in direct contact with any read/write head of the external system. Contact-less cards are suitable for use in transactions which are relatively frequent but involve relatively small amount of money.

A perennial problem associated with the manufacture of smart cards (and more particularly contact-less smart cards) is the securing of the IC module to the ends of the antenna coil. The physical connection between the IC module and the ends of the antenna coil must fulfill requirements on electrical conducting, strength, and aesthetic considerations.

For the resultant smart card to function properly and be acceptable, three essential requirements have to be met. Firstly, the connection between the IC module and the ends of the antenna coil must be electrically conducting. Secondly, the connection must be secure to avoid un-intentional disconnection or unreliable contact. Thirdly, the process of securing the IC module to the antenna coil must not adversely affect the outward appearance of the smart card.

One usual way of securing the IC module to the ends of the antenna coil is by soldering. However, it is well known that solder is environmentally unfriendly, and use of solder is now generally discouraged. Although it has been proposed to secure the IC module with the ends of the antenna coil by welding, it is found in practice that the high temperature required for melting the copper of the antenna coil will make the resultant smart card aesthetically unacceptable.

### SUMMARY OF THE INVENTION

It is thus an object of the present invention to provide a method of manufacturing a smart card in which the aforesaid shortcomings are mitigated or at least to provide a useful alternative to the trade and public.

According to a first aspect of the present invention, there is provided a method of manufacturing a card embedded with at least one integrated circuit module and an antenna coil, said method including steps (a) embedding an antenna coil on a core sheet, (b) laminating said core sheet with at least two outer sheets to form a laminated panel, (c) forming at least one cavity in said laminated panel to expose at least two ends of said antenna coil, and (d) connecting two electric contact regions of an integrated circuit module with said exposed ends of said antenna coil by a mezzanine electrode diffusion welding method as controlled by a transformer output manipulation energy output control method.

According to a second aspect of the present invention, there is provided a card embedded with at least one integrated circuit module and an antenna coil, said card being manufactured by a method including steps (a) embedding an antenna coil on a core sheet, (b) laminating said core sheet with at least two outer sheets to form a laminated panel, (c) forming at least one cavity in said laminated panel to expose at least two ends of said antenna coil, and (d) connecting two electric contact regions of an integrated circuit module with said exposed ends of said antenna coil by a mezzanine electrode diffusion welding method as controlled by a transformer output manipulation energy output control method.

### BRIEF DESCRIPTION OF THE DRAWINGS

A method of manufacturing a smart card according to an embodiment of the present invention will now be described, by way of an example only, with reference to the accompany drawings, in which:

FIG. 1 shows a length of copper wire embedded onto a core sheet for forming an antenna coil in a smart card according to the present invention;

FIG. 2 shows the core sheet of FIG. 1 to be piled up and aligned with various outer sheets for lamination according to the present invention;

FIG. 3 shows a laminated panel after lamination of the core sheet and outer sheets shown in FIG. 2;

FIG. 4 shows a card punched out from the laminated panel of FIG. 3;

FIG. 5A shows the card of FIG. 4 after formation of a trough, exposing two ends of the embedded antenna coil;

FIG. 5B is an enlarged view of the encircled part marked A in FIG. 5A;

FIGS. 6A to 6I show steps of forming a smart card from the card of FIG. 5A, in which FIG. 6D is an enlarged view of the encircled part marked B in FIG. 6C; and,

FIG. 7 is a schematic view showing a connection wire being welded with an exposed end of the antenna coil of FIG. 6D by a method according to the present invention.

### DETAILED DESCRIPTION OF THE INVENTION

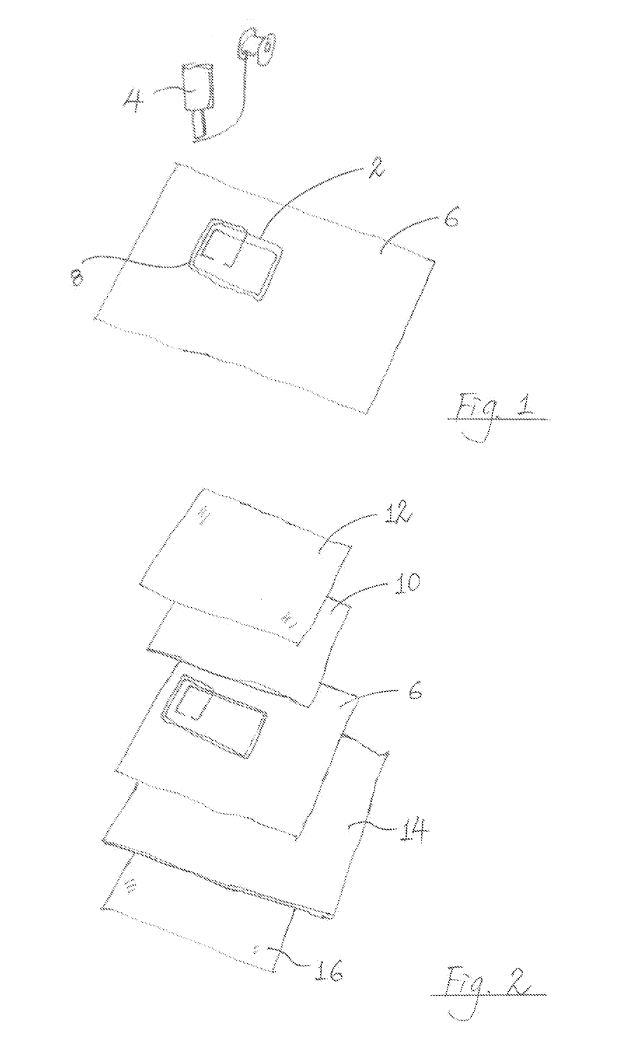

As shown in FIG. 1, a length of copper wire 2 has been embedded by an ultrasonic wiring machine 4 onto a core sheet 6. The core sheet 6 is usually made of a thermoplastic material (e.g. plexiglass, polyvinyl chloride (PVC), polypropylene (PP) and acrylonitrile butadiene-styrene (ABS)) or a heat-resistant material (e.g. epoxy-fiberglass) coated with a thin layer (e.g. about the diameter of the wire 2) of a partially coated thermoset adhesive.

A stylus of the ultrasonic wiring machine 4 may be set into up-and-down movement at an ultrasonic frequency. Such a vibration creates heat which melts the material of the core sheet 6 under the wire 2. Downward force on the stylus pushes the wire 2 into the core sheet 6. The softened thermoplastic material will quickly harden when the stylus moves forward, thus locking the wire 2 in place in the core sheet 6. At the end of the path, the wire 2 is cut by a small shear near the tip of the stylus. The wire 2 so embedded forms an antenna coil 8 for reception and transmission of radio frequency (RF) signals, whereby data may be written into and/or read from an integrated circuit (IC) module attached with the antenna coil 8.

As shown in FIG. 2, the core sheet 6 may then be positioned between various outer sheets 10, 12, 14, 16 and aligned for lamination. Such outer sheets 10, 12, 14, 16 may be filler sheets, protection sheets, graphical printing sheets and outer transparent sheets, depending on the purpose of the resultant smart card.

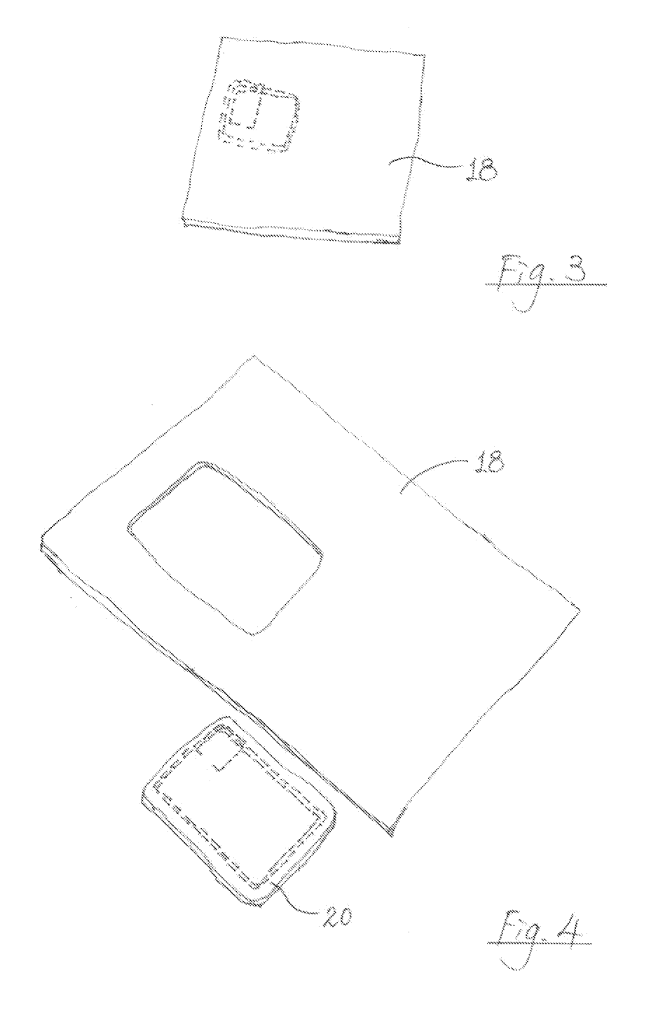

When the core sheet 4 and outer sheets 10, 12, 14, 16 are properly piled up and aligned with one another, such will be spot-welded to ensure that they will remain at the proper relative position during lamination. During lamination, the piled up and aligned core sheet 4 and outer sheets 10, 12, 14, 16 are secured with one another under pressure and high temperature in a lamination machine to form a laminated card panel 18, as shown in FIG. 3. A card 20 is then cut out (e.g. by punching) from the card panel 18, as shown in FIG. 4, for further process.

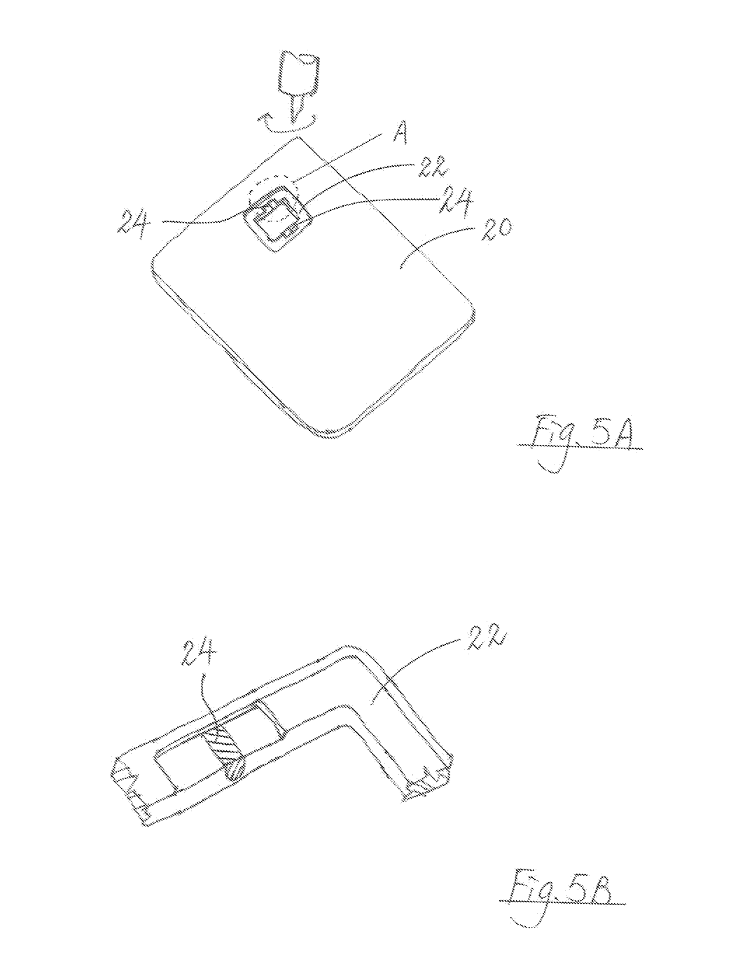

As shown in FIG. 5A, a generally rectangular cavity 22 is formed on the card 20 by milling. The cavity 22 is sized and shaped to receive an integrated circuit (IC) module. More particularly, after milling, two ends 24 of the antenna coil 8 are exposed to the outside environment.

As shown more clearly in FIG. 5B, in which only one end 24 of the antenna coil 8 is shown, the end 24 of the antenna coil 8 is exposed to the outside environment. The exposed ends 24 of the antenna coil 8 are each of a diameter of 0.1 mm to 0.2 mm.

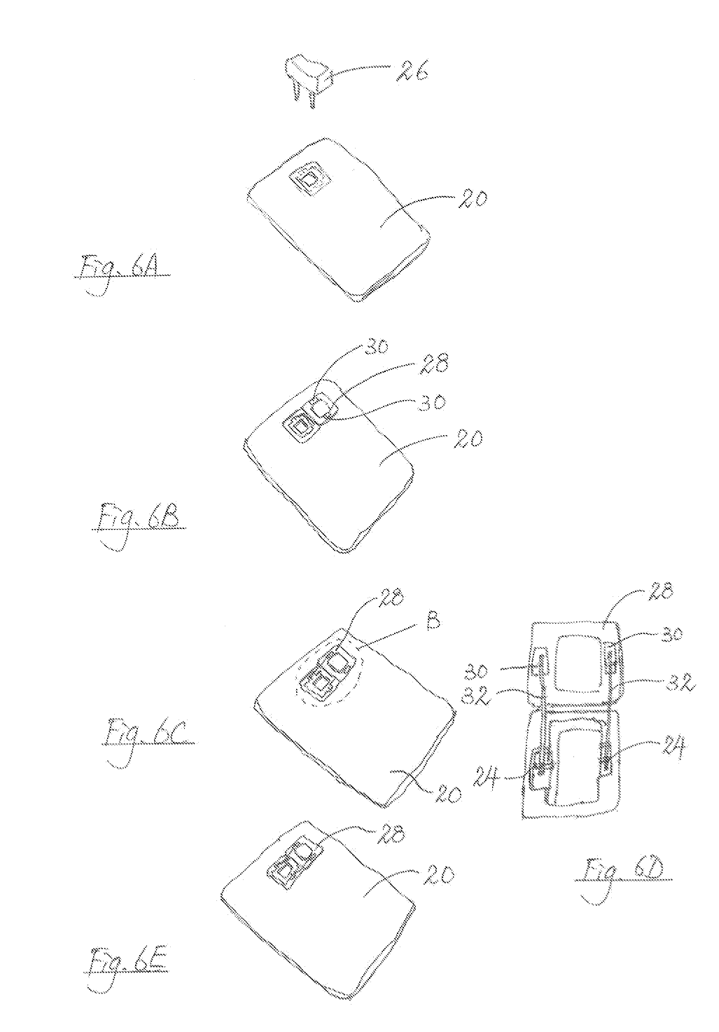

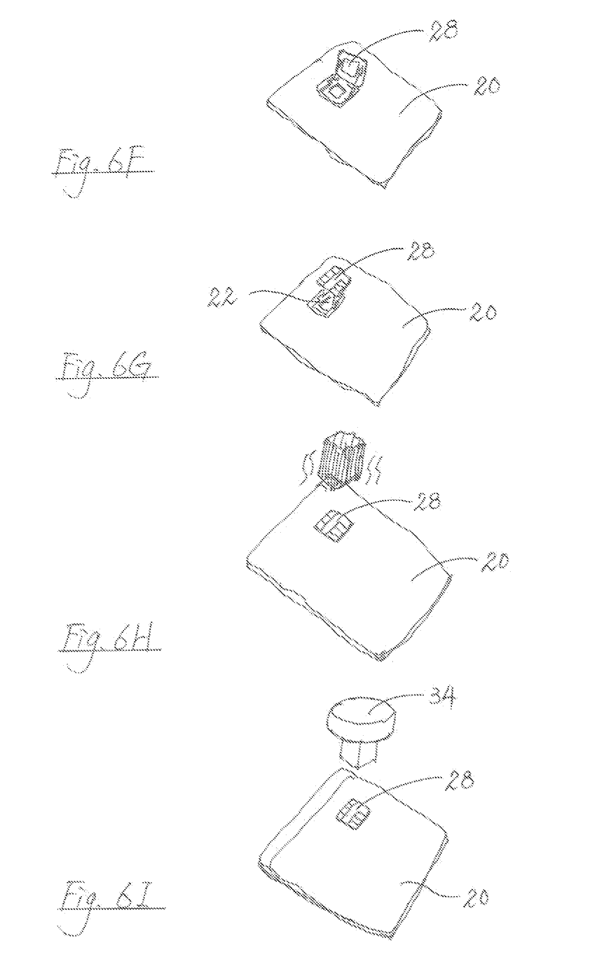

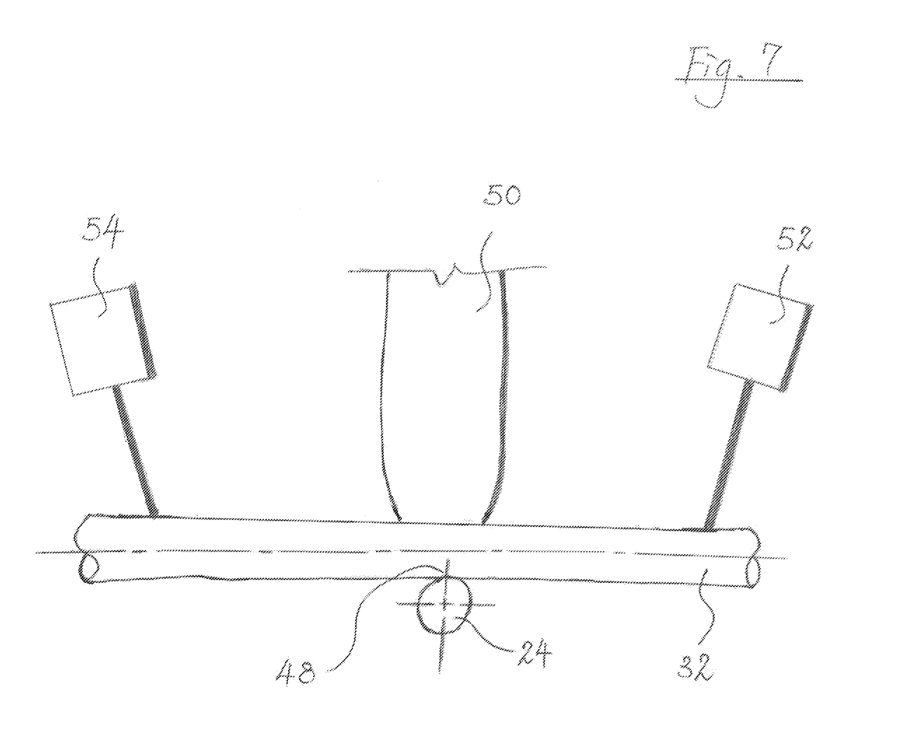

Turning to FIG. 6A, a vision system 26 is moved to view the two exposed ends 24 to confirm whether insulated coatings of the two ends 24 are removed such that the ends 24 are electrically conductive. An integrated circuit (IC) module 28 is then punched out with pre-bond heat activated bonding film on a bottom surface of the IC module 28.

As shown in FIGS. 6C and 6D, two electrically conducting connection wires (such as copper wires of a diameter of 0.1 mm to 0.2 mm) 32 are provided for electrically connecting the IC module 28 with the antenna coil 8. In particular, each connecting wire 32 is connected adjacent one end with one of the contact pads 30 of the IC module 28 and adjacent another end with an exposed end 24 of the antenna coil 8.

In the present invention, connection between the connecting wires 32 with the contact pads 30 of the IC module 28 and with the exposed ends 24 of the antenna coil 8 is achieved by a mezzanine electrode diffusion welding method as controlled by a transformer output manipulation energy output control method. A method and machine for carrying out transformer output manipulation energy output control method is disclosed in U.S. Pat. No. 8,416,583. However, such a method was originally designed for production of electric batteries and battery assemblies. It was subsequently discovered, through experiments and trials by the present inventor, that, with adjustment of relevant operating parameters of a transformer output manipulation energy output control machine, it is possible to employ transformer output manipulation energy output control method to physically connect the connecting wires 32 with the contact pads 30 of the IC module 28 and with the exposed ends 24 of the antenna coil 8, while achieving the three essential requirements mentioned above. More particularly, the connection between the contact pads 30 of the IC module 28 and the exposed ends 24 of the antenna coil 8 via the connection wires 32 is electrically conducting and secure. In addition, the transformer output manipulation energy output control method used for achieving the connection does not adversely affect the outward appearance of the smart card 20.

After electrically and physically connecting the IC module 28 with the exposed ends 24 of the antenna coil 8 via the connection wires 32, and as shown in FIG. 6E, the IC module 28 is turned upwardly, as shown in FIG. 6F, to be eventually aligned with the cavity 22 of the card 20, as shown in FIG. 6G. The IC module 28 is then embedded into the cavity 22 of the card 20, as shown in FIG. 6H. A heating head which transfers heat energy to the surface of the IC module 28 is a simple heating element with temperature control. The heat applied to the IC module 28 will also activate the head activated bonding film on the IC module 28 to affix the IC module 28 to the cavity 22 of the card 20. A cooling head 34 is then moved to contact the IC module 28 to cool down the surface of the IC module 28. A smart card 20 is thus obtained.

As shown in FIG. 7, during welding of the connection wire 32 with an exposed end 24 of the antenna coil 8 to electrically and physically connect the IC module 28 with the exposed end 24 of the antenna coil 8, the connection wire 32 lies on and contacts the exposed end 24 at a point of contact 48. The connection wire 32 is generally perpendicular to the exposed end 24 of the antenna coil 8.

The welding machine for carrying out the method according to the present invention includes a press head 50 and two electrical terminals 52, 54. During welding of the connection wire 32 with the exposed end 24 of the antenna coil 8, the press head 50 and the two electrical terminals 52, 54 simultaneously contact the connection wire 32 on a side of the connection wire 32 opposite the point of contact 48. For welding the connection wire 32 with the exposed end 24 of the antenna coil 8 according to a method of the present invention, a direct current (d.c.) voltage of 0.4 volts to 0.45 volts is applied between the electrical terminals 52 and 54, an electric current of 190 A to 200 A flows from the electric terminal 52 to the electric terminal 54, and the press head 50 applies a force of 0.48 kgf to 0.52 kgf on the connection wire 32.

The method according to the present invention may be used for manufacturing such smart cards as dual interface cards (which are also called combi-cards).

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. A method of manufacturing a card embedded with at least one integrated circuit module and an antenna coil, said method including steps:
(a) embedding an antenna coil on a core sheet,
(b) laminating said core sheet with at least two outer sheets to form a laminated panel,
(c) forming at least one cavity in said laminated panel to expose at least two ends of said antenna coil, and
(d) connecting two electric contact regions of an integrated circuit module with said exposed ends of said antenna coil by a mezzanine electrode diffusion welding method as controlled by a transformer output manipulation energy output control method.

2. The method according to claim 1 wherein, in said step (d), each of said two exposed ends of said antenna coil is connected with one of said two electric contact regions of said integrated circuit module via a respective electrically conducting wire.

3. The method according to claim 2 wherein said step (d) is carried out by a transformer output manipulation energy output control machine.

4. The method according to claim 3 wherein said machine includes a press head and two electrical terminals.

5. The method according to claim 4 wherein, during connection of said electrically conducting wire with one of said exposed ends of said antenna coil, said press head and said two electrical terminals contact said electrically conducting wire.

6. The method according to claim 4 wherein, during connection of said electrically conducting wire with one of said exposed ends of said antenna coil, a direct current voltage of 0.4 volts to 0.45 volts is applied between said electrical terminals.

7. The method according to claim 4 wherein, during connection of said electrically conducting wire with one of said exposed ends of said antenna coil, an electric current of 190 A to 200 A flows from one of said electric terminals to another of said electric terminals.

8. The method according to claim 4 wherein, during connection of said electrically conducting wire with one of said exposed ends of said antenna coil, said press head applies a force of 0.48 kgf to 0.52 kgf on said electrically conducting wire.

9. The method according to claim 5 wherein, during connection of said electrically conducting wire with one of said exposed ends of said antenna coil, a direct current voltage of 0.4 volts to 0.45 volts is applied between said electrical terminals.

10. The method according to claim 5 wherein, during connection of said electrically conducting wire with one of said exposed ends of said antenna coil, an electric current of 190 A to 200 A flows from one of said electric terminals to another of said electric terminals.

11. The method according to claim 6 wherein, during connection of said electrically conducting wire with one of said exposed ends of said antenna coil, an electric current of 190 A to 200 A flows from one of said electric terminals to another of said electric terminals.

12. The method according to claim 5 wherein, during connection of said electrically conducting wire with one of said exposed ends of said antenna coil, said press head applies a force of 0.48 kgf to 0.52 kgf on said electrically conducting wire.

13. The method according to claim 6 wherein, during connection of said electrically conducting wire with one of said exposed ends of said antenna coil, said press head applies a force of 0.48 kgf to 0.52 kgf on said electrically conducting wire.

14. The method according to claim 7 wherein, during connection of said electrically conducting wire with one of said exposed ends of said antenna coil, said press head applies a force of 0.48 kgf to 0.52 kgf on said electrically conducting wire.

15. A card embedded with at least one integrated circuit module and an antenna coil, said card being manufactured by the method according to claim 1.
